(19) United States
(12) Patent Application Publication
(10) Pub. No.: US 2021/0347387 A1
(43) Pub. Date: Nov. 11, 2021

(54) TRAFFIC RECONSTRUCTION VIA COOPERATIVE PERCEPTION

(71) Applicant: Toyota Motor Engineering & Manufacturing North America, Inc., Plano, TX (US)

(72) Inventors: Sergei Avedisov, Cupertino, CA (US); Onur Altintas, Mountain View, CA (US)

(21) Appl. No.: 16/868,686

(22) Filed: May 7, 2020

(51) Int. Cl. B60W 60/00; G08G 1/01; B60W 50/14; B60W 40/04

(52) U.S. Cl. CPC B60W 60/00276; G08G 1/0129; G08G 1/0133; G06K 9/00791; B60W 50/14; B60W 40/04; B60W 60/0016

(57) ABSTRACT

A traffic reconstruction can be generated use cooperative perception messages and other data received from a plurality of different remote sources, such as connected vehicles and/or connected infrastructure devices, at different times. The received data can include at least position data of one or more objects in the driving environment. The received data can be stitched together to create a traffic reconstruction of surrounding traffic. The traffic reconstruction can incorporate visual data of detected objects so that a “panoramic video” of surrounding traffic is generated. The fusion of the data from the various remote vehicles is done not only in space but in time. Dynamic models and/or other rules or constraints can be used in generating the traffic reconstruction.

### FIELD

The subject matter described herein relates in general to connected devices and, more particularly, to cooperative perception among connected devices.

### BACKGROUND

Some vehicles include sensors that are configured to detect information about the surrounding environment. As an example, some vehicles can include sensors that can detect the presence of other vehicles and objects in the environment, as well as information about the detected objects. Further, some vehicles can include computing systems that can process the detected information for various purposes. For instance, the computing systems can determine how to navigate and/or maneuver the vehicle through the surrounding environment.

### SUMMARY

In one respect, the subject matter presented herein relates to a traffic reconstruction system. The system includes one or more processors. The one or more processors can be programmed to initiate executable operations. The executable operations can include receiving driving environment data from at least one of a plurality of connected vehicles and one or more infrastructure devices at different moments in time. The driving environment data include at least position data of one or more objects in the driving environment. The executable operations can further include analyzing the received driving environment data to generate a traffic reconstruction. The traffic reconstruction can span over space and time between the different moments in time.

In another respect, the subject matter presented herein relates to a traffic reconstruction method. The method can include receiving driving environment data from at least one of a plurality of connected vehicles and one or more infrastructure devices at different moments in time. The driving environment data include at least position data of one or more objects in the driving environment. The method can also include analyzing the received driving environment data to generate a traffic reconstruction. The traffic reconstruction can span over space and time between the different moments in time.

In still another respect, the subject matter presented herein relates to a computer program product for traffic reconstruction. The computer program product can include a computer readable storage medium having program code embodied therewith. The program code executable by a processor to perform a method. The method can include receiving driving environment data from at least one of a plurality of connected vehicles and one or more connected infrastructure devices at different moments in time. The driving environment data include at least position data of one or more objects in the driving environment. The method can further include analyzing the received driving environment data to generate a traffic reconstruction. The traffic reconstruction can span over space and time between the different moments in time.

### BRIEF DESCRIPTION OF THE DRAWINGS

FIG. 1 is an example of a traffic reconstruction system.

FIG. 2 is an example of an ego vehicle.

FIG. 3 is an example of a connected vehicle.

FIG. 4 is an example of an infrastructure device.

FIG. 5 is an example of a traffic reconstruction method.

FIG. 6 is an example of a traffic reconstruction module.

FIGS. 7A-7B show an example of a driving scenario at a first moment in time and a second moment in time, respectively.

FIG. 8 show an example of traffic reconstruction of the scenarios shown in FIGS. 7A and 7B.

FIGS. 9A-9B show an example of a driving scenario including an ego vehicle at a first moment in time and a second moment in time, respectively.

FIG. 10 A shows the speed and position data of a detected object in the driving scenario shown in FIG. 9A.

FIG. 10B shows an example of an operation of the traffic reconstruction module, showing the speed of the object at the first moment in time as well as an extrapolation of the speed of the object within probabilistic bounds.

FIG. 10C shows an example of an operation of the traffic reconstruction module, showing the position of the object at the first moment in time as well as an extrapolation of the position of the object within probabilistic bounds.

FIG. 11A shows the speed and position data of a detected object in the driving scenario shown in FIG. 9B.

FIG. 11B shows an example of an operation of the traffic reconstruction module, showing the speed of the object at the second moment in time as well as an extrapolation of the speed of the object within probabilistic bounds.

FIG. 11C shows an example of an operation of the traffic reconstruction module, showing the position of the object at the second moment in time as well as an extrapolation of the position of the object within probabilistic bounds.

FIG. 12A shows an example of an operation of the traffic reconstruction module, showing the speed data for the object, including extrapolations, associated with the first and second moments in time being overlaid.

FIG. 12B shows an example of an operation of the traffic reconstruction module, showing the position data for the object, including extrapolations, associated with the first and second moments in time being overlaid.

FIG. 13A shows an example of an operation of the traffic reconstruction module, showing a traffic reconstruction of a speed profile for the object.

FIG. 13B shows an example of an operation of the traffic reconstruction module, showing a traffic reconstruction of a position profile for the object.

FIGS. 14A-14B show an example of a driving scenario including a connected billboard at a first moment in time and a second moment in time, respectively.

FIG. 15 shows an example of the information received by the connected billboard for the driving scenarios shown in FIGS. 14A-14B.

FIG. 16 shows an example of an output generated by the traffic reconstruction module(s) based on the information received by the connected billboard for the driving scenarios shown in FIGS. 14A-14B.

### DETAILED DESCRIPTION

According to arrangements herein, a vehicle and/or an infrastructure device can use driving environment data received from different remote sources (e.g., vehicles, infrastructure devices, etc.) at different moments in time. The driving environment data can be sent by the remote sources in any suitable manner and/or form. For instance, the driving environment data can be sent as raw data, a subset of acquired driving environment data, and/or as part of a cooperative perception message or other type of message. The vehicle and/or an infrastructure device can also use driving environment data acquired by its own sensors.

The vehicle and/or an infrastructure device can combine (or stitch together) the received information to generate a traffic reconstruction of surrounding traffic. The traffic reconstruction can be a “panoramic video” of surrounding traffic. The fusion of the data from the various remote vehicles can be done not only in space but in time. Dynamic models can be used in generating the traffic reconstruction. In this way, the driving environment can be cooperatively perceived by the vehicle and/or an infrastructure device. The perception can be considered to be “cooperative” in that the receiving device (e.g., the vehicle and/or the infrastructure device) can use driving environment data from various remote sources (e.g., vehicles, infrastructure, etc.) to attain a holistic picture of the driving environment. Of course, the receiving device can also use data captured by its own sensors.

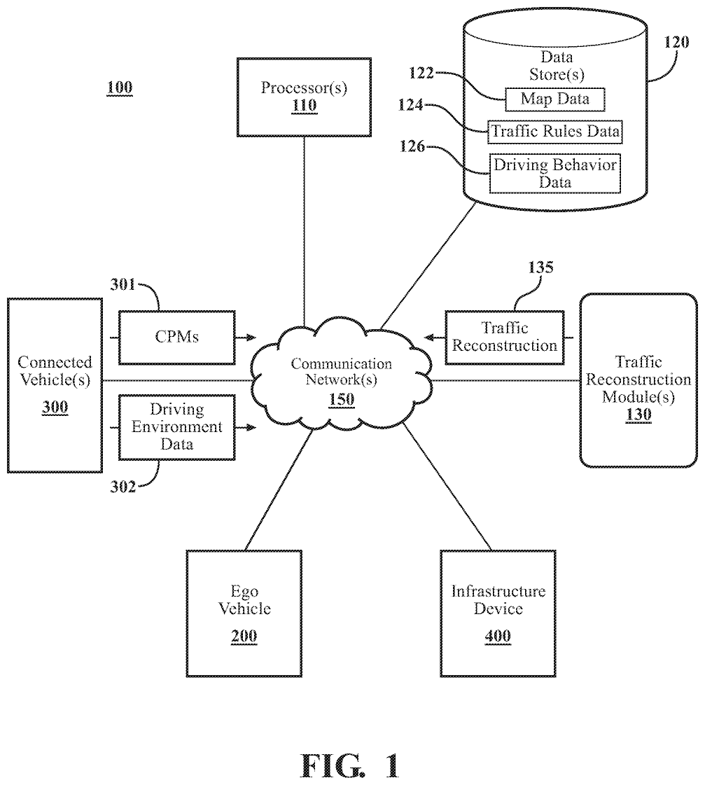

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-16, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIG. 1 is an example of a traffic reconstruction system 100. Some of the possible elements of the traffic reconstruction system 100 are shown in FIG. 1 and will now be described. It will be understood that it is not necessary for the traffic reconstruction system 100 to have all of the elements shown in FIG. 1 or described herein. The traffic reconstruction system 100 can include a one or more processors 110, one or more data stores 120, one or more traffic reconstruction modules 130, an ego vehicle 200, one or more infrastructure devices 400, and/or one or more connected vehicles 300.

The various elements of the traffic reconstruction system 100 can be communicatively linked through one or more communication networks 150. As used herein, the term “communicatively linked” can include direct or indirect connections through a communication channel or pathway or another component or system. A “communication network” means one or more components designed to transmit and/or receive information from one source to another. The communication network(s) 150 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network(s) 150 further can be implemented as or include one or more wireless networks, whether short or long range. For example, in terms of short range wireless networks, the communication network(s) 150 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communication network(s) 150 can include a mobile, cellular, and or satellite-based wireless network and support voice, video, text, and/or any combination thereof. Examples of long range wireless networks can include GSM, TDMA, CDMA, WCDMA networks or the like. The communication network(s) 150 can include wired communication links and/or wireless communication links. The communication network(s) 150 can include any combination of the above networks and/or other types of networks. The communication network(s) 150 can include one or more routers, switches, access points, wireless access points, and/or the like. In one or more arrangements, the communication network(s) 150 can include Vehicle-to-Vehicle (V2V), Vehicle-to-Infrastructure (V2I), or Vehicle-to-Everything (V2X) technology, which can allow for communications between the connected vehicle(s) 300 and the ego vehicle 200 and/or the infrastructure device 400.

One or more elements of the traffic reconstruction system 100 include and/or can execute suitable communication software, which enables two or more of the elements to communicate with each other through the communication network(s) 150 and perform the functions disclosed herein.

In the traffic reconstruction system 100, the traffic reconstruction module(s) 130 can be configured to receive driving environment data from the connected vehicle(s) 300 and/or the infrastructure device(s) 400 at different times. In one or more arrangements, the driving environment data can be sent in a cooperative perception message (CPM) 301. The cooperative perception messages 301 can allow remote connected devices to relay their sensed information to an ego vehicle or an infrastructure device at different times. Alternatively or additionally, the driving environment data can be sent as driving environment data 302 in any suitable manner. For example, the driving environment data 302 can be raw sensor data. In some instances, the driving environment data 302 can be a subset (e.g., less than all) of all driving environment data acquired by a remote source at a moment in time. For instance, the driving environment data 302 can include only particular data of interest (e.g., position, speed, heading angle, acceleration, or any combination thereof) about an object.

The cooperative perception messages 301 can include any suitable information. For instance, the cooperative perception messages 301 can include at least position data of detected objects in the driving environment. In some arrangements, the cooperative perception messages 301 can further include speed data of detected objects in the driving environment. In some arrangements, the cooperative perception messages 301 can include acceleration data and/or heading angle data of a detected object, which can also be helpful in generating a traffic reconstruction. The cooperative perception messages 301 can include any information relating to the position, orientation, and/or movement of detected objects in the driving environment.

The driving environment data 302 can include any other information about the driving environment, including the above-noted information about the objects and/or additional information about the objects. As an example, the driving environment data 302 can include camera data of an object in the driving environment. In some instances, the driving environment data 302 may be included as a part of the cooperative perception message 301. Alternatively, in some instances, the driving environment data 302 can be sent separately from the cooperative perception message 301.

The traffic reconstruction module(s) 130 can be configured to generate a traffic reconstruction 135. The traffic reconstruction 135 can use the cooperative perception messages 301 and the driving environment data 302 from different connected vehicles 300 at different times to create a traffic reconstruction. The traffic reconstruction 135 can include speed and location profiles of one or more objects in the driving environment. Thus, the fusion of the cooperative perception messages 301 and the driving environment data 302 is done not only in space but in time. The traffic reconstruction 135 can include a “panoramic video” of surrounding traffic by using visual data of the detected object(s) combined with the speed and location profiles. The traffic reconstruction 135 can show the movement of the object(s) over space and time. The traffic reconstruction 135 can enable the object(s) to be viewed from multiple angles. The traffic reconstruction 135 can be stored in the data stores(s) 120 or used for other purposes described herein.

It should be noted that the processor(s) 110, the data store(s) 120, and/or the traffic reconstruction module(s) 130 can be located on the ego vehicle 200. In one or more arrangements, the processor(s) 110, the data store(s) 120, and/or the traffic reconstruction module(s) 130 can be located on the infrastructure device 400. In some arrangements, the processor(s) 110, the data store(s) 120, and/or the traffic reconstruction module(s) 130 can be located remote from the ego vehicle 200 and/or the infrastructure device 400.

It should be noted that the connected vehicle(s) 300 can be any vehicle that is that is communicatively coupled to the ego vehicle 200 and/or to the infrastructure device 400. As used in connection with the ego vehicle 200 and the connected vehicle(s) 300, the term “vehicle” means any form of motorized transport, now known or later developed. Non-limiting examples of vehicles include automobiles, motorcycles, aerocars, or any other form of motorized transport. While arrangements herein will be described in connection with land-based vehicles, it will be appreciated that arrangements are not limited to land-based vehicles. Indeed, in some arrangements, the vehicle can be water-based or air-based vehicles. The ego vehicle 200 and/or the connected vehicle(s) 300 may be operated manually by a human driver, semi-autonomously by a mix of manual inputs from a human driver and autonomous inputs by one or more vehicle computers, fully autonomously by one or more vehicle computers, or any combination thereof.

“Infrastructure device” can be any device positioned along or near a road or other travel path. The infrastructure device 400 can be, for example, a street light, traffic light, a smart traffic light, a traffic sign, a road sign, a billboard, a bridge, a building, a pole, or a tower, just to name a few possibilities. In some instances, the infrastructure device 400 may be a road itself when the operative components are embedded therein. In some arrangements, the infrastructure device 400 can be configured to send and/or receive information. The infrastructure device 400 can include one or more sensors for sensing the surrounding environment. In some arrangements, the infrastructure device 400 can be substantially stationary.

As noted above, the traffic reconstruction system 100 can include one or more processors 110. “Processor” means any component or group of components that are configured to execute any of the processes described herein or any form of instructions to carry out such processes or cause such processes to be performed. The processor(s) 110 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 110 can include at least one hardware circuit (e.g., an integrated circuit) configured to carry out instructions contained in program code. In arrangements in which there is a plurality of processors 110, such processors can work independently from each other or one or more processors can work in combination with each other.

The traffic reconstruction system 100 can include one or more data stores 120 for storing one or more types of data. The data store(s) 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 120 can be a component of the processor(s) 110, or the data store(s) 120 can be operatively connected to the processor(s) 110 for use thereby. The term “operatively connected,” as used throughout this description, can include direct or indirect connections, including connections without direct physical contact.

In one or more arrangements, the data store(s) 120 can include map data 122. The map data 122 can include maps of one or more geographic areas. In some instances, the map data 122 can include information or data on roads, traffic control devices, road markings, street lights, structures, features, and/or landmarks in the one or more geographic areas. The map data 122 can include information about ramps, merging points between the ramps and the main lanes, and geo-fences surrounding the merging points. The map data 122 can be in any suitable form. In some instances, the map data 122 can include aerial views of an area. In some instances, the map data 122 can include ground views of an area, including 360 degree ground views. The map data 122 can include measurements, dimensions, distances, positions, coordinates, and/or information for one or more items included in the map data 122 and/or relative to other items included in the map data 122. The map data 122 can include a digital map with information about road geometry. In one or more arrangement, the map data 122 can include information about the ground, terrain, roads, surfaces, and/or other features of one or more geographic areas. The map data 122 can include elevation data in the one or more geographic areas. The map data 122 can define one or more ground surfaces, which can include paved roads, unpaved roads, land, and other things that define a ground surface. The map data 122 can be high quality and/or highly detailed.

In one or more arrangements, the data store(s) 120 can include traffic rules data 124. As used herein, “traffic rule” is any law, rule, ordinance or authority that governs the operation of a vehicle, including vehicles in motion and vehicles that are parked or otherwise not in motion. The traffic rules data 124 can include data on instances, situations, and/or scenarios in which a motor vehicle is required to stop or reduce speed. The traffic rules data 124 can include speed limit data. The traffic rules data 124 can include international, federal, national, state, city, township and/or local laws, rules, ordinances and/or authorities. The traffic rules data 124 can include data on traffic signals and traffic signs.

The one or more data stores 120 can include driving behavior data 126. The driving behavior data 126 can be any information, data, parameters, assumptions, and/or models that approximate a driving behavior (human, autonomous vehicle, and/or other entity) in a driving environment. For example, the driving behavior data 126 can include car following rules, lane changing rules, and/or merging rules, now known or later developed. As an example of a car following rule, a following vehicle can be assumed to maintain a certain speed relative to the leading vehicle and/or to maintain a minimum following distance. As an example of a lane changing rule, if a time interval between two data points about a vehicle is below a threshold amount of time and if the vehicle is in the same travel lane at each data point, then it can be assumed that the vehicle has remained in the same lane.

The driving behavior data 126 can include any suitable dynamic model(s) and/or simulator(s) for interpolating and/or extrapolating the behavior of a vehicle based on known information. For example, when information about a vehicle is known at two different moments in time, the dynamic models and/or the simulator may be able to interpolate and/or extrapolate a vehicle's behavior between these two different moments in time. The driving behavior data 126 can include historical vehicle behaviors and/or future intended vehicle behavior (such as intended trajectory or an intended maneuver). The driving behavior data 126 can be in one or more locations, at different times (e.g., day, week, year, etc.), under different weather conditions, and/or under different traffic conditions, just to name a few possibilities. The driving behavior data 126 can include macroscopic and/or microscopic traffic models.

The traffic reconstruction module(s) 130 can be implemented as computer readable program code that, when executed by a processor, implement one or more of the various processes described herein. The traffic reconstruction module(s) 130 can be a component of one or more of the processor(s) 110 or other processor(s) (e.g., one or more processors(s) of the ego vehicle 200 or one or more processor(s) of the infrastructure device 400), or the traffic reconstruction module(s) 130 can be executed on and/or distributed among other processing systems to which one or more of the processor(s) 110 is operatively connected. In one or more arrangements, the traffic reconstruction module(s) 130 can include artificial or computational intelligence elements, e.g., neural network, fuzzy logic or other machine learning algorithms.

The traffic reconstruction module(s) 130 and/or the data store(s) 120 can be components of the processor(s) 110. In one or more arrangements, the traffic reconstruction module(s) 130 and/or the data store(s) 120 can be stored on, accessed by and/or executed on the processor(s) 110. In one or more arrangements, the traffic reconstruction module(s) 130 and/or the data store(s) 120 can be executed on and/or distributed among other processing systems to which the processor(s) 110 is communicatively linked.

The traffic reconstruction module(s) 130 can include instructions (e.g., program logic) executable by a processor. Alternatively or in addition, one or more of the data stores 120 may contain such instructions. Such instructions can include instructions to execute various functions and/or to transmit data to, receive data from, interact with, and/or control one or more elements of the traffic reconstruction system 100. Such instructions can enable the various elements of the traffic reconstruction system 100 to communicate through the communication network 150.

The traffic reconstruction module(s) can be configured to receive sensor information from a plurality of vehicles. Based on the time the sensor information was detected, the position of the detecting sensors as well as the position of the detected objects (such as vehicles), the system can combine (or stitch together) the received information to determine the speed of the detected vehicles are traveling at and the positions of the detected vehicles. This “stitching together” may involve (but is not limited to) interpolation of vehicle states via first principle models and/or statistical/Bayesian models. The traffic reconstruction module(s) 130 can be configured to generate a traffic reconstruction based on the received data.

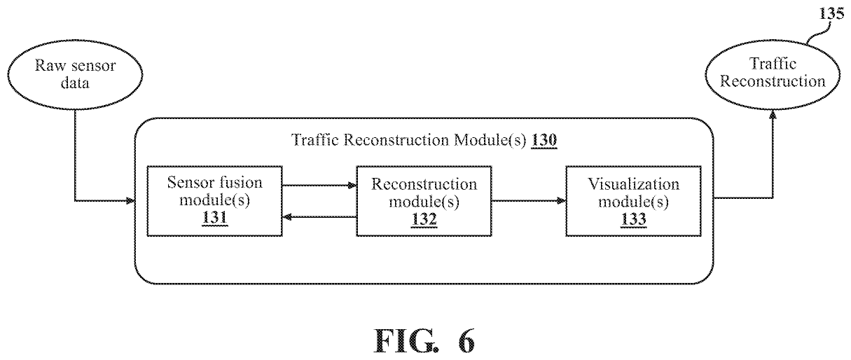

Referring to FIG. 6, the traffic reconstruction module(s) 130 can, in at least some arrangements, include one or more submodules, such as a sensor fusion module 131, a reconstruction module 132, and/or a visualization module 133. The sensor fusion module 131 can receive all relevant sensory and/or wireless data from one or more elements of the traffic reconstruction system 100. The sensor fusion module 131 can collect all data relevant to a certain time interval over which the traffic reconstruction is to occur. Alternatively, the sensor fusion module can select a subset of the data received from all sources. The subset can be less than all of the data received. In one or more arrangements, the subset can be temporal-based. The sensor fusion module(s) 131 can identify the critical objects (vehicles) in the received data. Thus, the sensor fusion module(s) 131 can include any suitable object recognition modules, now known or later developed. The sensor fusion module(s) 131 can determine a suitable coordinate system to represent the objects collected from all the sensors or a subset of all the sensors.

The reconstruction module(s) 132 can be configured to fuse the received information in time. Based on the data received from the sensor fusion module(s) 131 as well as models (such as probabilistic models, first principle models, or a combination of such), the reconstruction module(s) 132 can calculate the most likely position of the object through the given time interval. The sensor fusion module(s) 131 and the reconstruction module(s) 132 can be configured to help each other. For instance, the modules can identify a single car from two different viewpoints at different times. Furthermore, the modules can then be used to interpolate the behavior of that car in between the observation times. Additional information about the reconstruction module(s) 132 can be found in the examples. The reconstruction module(s) 132 can perform any suitable statistical or mathematical analysis and/or operation to the received sensor data.

The visualization module(s) 133 can be configured to generate a traffic reconstruction in a form that can be displayed to a user or other entity. The visualization module(s) 133 can do so in any suitable manner. The visualization module(s) 133 can use camera data of a detected object from different angles (e.g., back view, full or partial side view, etc.) and at different times. If such data is available, then the visualization module(s) 133 can gain an understanding of what the object looks like (e.g., size, shape, and/or color of the vehicle from different angles). The visualization module(s) 133 can be configured to make certain assumptions. For instance, if there is camera data of the right side of the vehicle, then the visualization module(s) 133 can assume that the left side appears to be substantially the same.

With the position and speed of the vehicle known with high accuracy over the time interval between the first and second moments in time t₁ and t₂, the visualization module(s) 133 can be used to project a representation of the vehicle into different coordinate frames/viewpoints. With this understanding along with the trajectory information, the visualization module(s) 133 can reconstruct the how the vehicle looks from multiple angles as it proceeds along its trajectory. In this way, the visualization module(s) 133 can be said to generate a panoramic video.

The traffic reconstruction module(s) 130 can output the traffic reconstruction 135. The traffic reconstruction 135 can be sent to other vehicles, repositories, infrastructure, and/or to some other person or entity or data store. The traffic reconstruction 135 can be used for various purposes, such as decision making or other analysis.

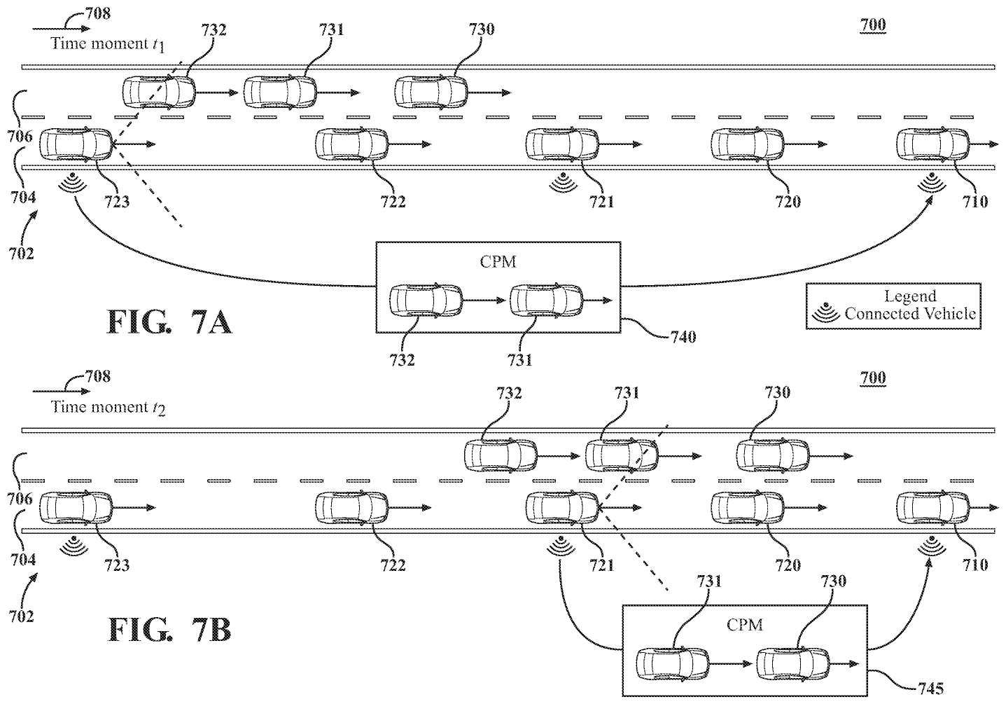

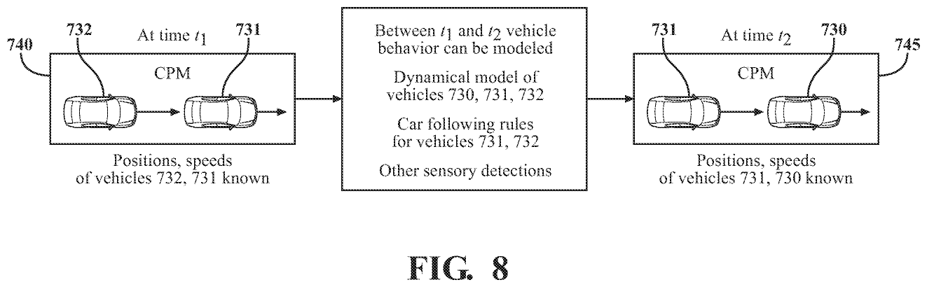

An example of the operation of the traffic reconstruction module(s) 130, particularly the sensor fusion module 131 and the reconstruction module 132, will now be described in connection with FIGS. 7-8.

Referring to FIG. 7A, a driving environment 700 at a first moment in time is shown. The driving environment 700 can include a road 702 with a first travel lane 704 and a second travel lane 706. The travel direction 708 of the first travel lane 704 and the second travel lane 706 can be the same. The driving environment 700 can include an ego vehicle 710. In this example, the driving environment 700 can include connected vehicles 721, 723. Vehicles 720, 722, 730, 731, 732 can be connected vehicles, non-connected vehicles, or any combination thereof. A non-connected vehicle is a vehicle that is not communicatively coupled to the ego vehicle 710. The ego vehicle 710, the connected vehicles 721, 723, and the vehicles 720, 722 can be located in the first travel lane 704. The vehicles 730, 731, 732 can be located in the second travel lane 706.

FIG. 7A shows the driving environment 700 at a first moment in time t₁. At the first moment in time t₁, the connected vehicle 723 can sense the driving environment 700. The connected vehicle 723 can detect the vehicles 731, 732. More particularly, the connected vehicle 723 can detect the position and speed information about the vehicles 731, 732 at the first moment in time t₁. The connected vehicle 723 can send a cooperative perception message 740 to the ego vehicle 710. The cooperative perception message 740 can include position and speed information about the vehicles 731, 732 at the first moment in time t₁. While, in this example, the connected vehicle 723 sends the position and speed information to the ego vehicle 710 by the cooperative perception message 740, it will be appreciated that the connected vehicle 723 can send the position and speed information in any suitable manner, including in other manners that are not cooperative perception messages.

Referring to FIG. 7B, the driving environment 700 at a second moment in time t₂ is shown. The second moment in time t₂ being subsequent to the first moment in time t₁. The connected vehicle 721 can sense the driving environment. The connected vehicle 721 can detect the vehicles 730, 731. The connected vehicle 721 can send a cooperative perception message 745 to the ego vehicle 710. The cooperative perception message 745 can include position and speed information about the vehicles 730, 731 at the second moment in time t₂. While, in this example, the connected vehicle 721 sends the position and speed information to the ego vehicle 710 by the cooperative perception message 745, it will be appreciated that the connected vehicle 721 can send the position and speed information in any suitable manner, including in other manners that are not cooperative perception messages.

It should be noted that, in the example of FIGS. 7A-7B, the ego vehicle 710 is receiving information from trailing vehicles. However, it will be understood that arrangements are not limited to information from trailing vehicles. Indeed, the ego vehicle 710 can receive information from leading vehicles, adjacent vehicle, or any combination thereof. In some arrangements, the ego vehicle 710 may even use information from vehicles traveling in the opposite direction.

Further, in the example of FIGS. 7A-7B, the ego vehicle 710 can receive information about the vehicle 731 from different angles, which can provide useful information. If a vehicle can be observed from different angles, such as by camera data, then the reconstruction can include size, shape, and/or color of the vehicle from different angles. With this understanding along with the trajectory information, the reconstruction can include a video of the traffic.

In some arrangements, an ego vehicle or an infrastructure device can receive information (e.g., CPMs, driving environment data, etc.) from the connected vehicles on an ad hoc basis. Thus, the connected vehicles can be broadcasting information ad hoc, and the ego vehicle or the infrastructure device may receive it if it is within communication range. In some arrangements, an ego vehicle or infrastructure device can request information from one or more of the connected vehicles. For instance, if the ego vehicle or infrastructure device does not have enough information, the ego vehicle can request information. The request may be for particular information (within a certain distance, information from a particular location/area, etc.). Alternatively or additionally, the request may be for information from a particular vehicle. Using the example of FIG. 7A, the ego vehicle 710 may receive cooperative perception messages from the connected vehicles 721 and the connected vehicle 723. In such case, the ego vehicle 710 may request information from other connected vehicles in the driving environment 700. For example, if the vehicle 722 is a connected vehicle, then the ego vehicle 710 can request information from the vehicle 722. In some arrangements, the ego vehicle 710 may ignore, filter, delete, or assign a low priority to information received that is not accurate (e.g., high error) and/or is not within a desired distance from the ego vehicle 710 or not at a desired location.

The cooperative perception messages 740, 745 can be received by the traffic reconstruction module(s) 130. FIG. 8 show the information available to the traffic reconstruction module(s) 130. The traffic reconstruction module(s) 130 knows the position and speed of the vehicle 731 and the vehicle 732 at the first moment in time t₁. Thus, this information can define constraints at the first moment in time t₁. The traffic reconstruction module(s) 130 also knows the position and speed of the vehicle 730 and the vehicle 731 at the second moment in time t₂. This information can define constraints at the second moment in time t₂. The traffic reconstruction module(s) 130 can take into account other sensory detections (e.g., driving environment data) acquired by one or more of the connected vehicles and/or other driving environment detection sources (e.g., infrastructure devices).

Between the first and second moments in time t₁, t₂, the traffic reconstruction module(s) 130 can model the behavior of the vehicles. There are various ways in which the traffic reconstruction module(s) 130 can model the behavior of these vehicles. For instance, the traffic reconstruction module(s) 130 can recognize that the vehicle 731 and the vehicle 732 are located behind other vehicles. Therefore, the traffic reconstruction module(s) 130 can apply car following rules to their motion. Alternatively or in addition, the traffic reconstruction module(s) 130 can apply a dynamic model for the movement of the vehicles 730, 731, 732. The traffic reconstruction module(s) 130 can also take into account other information received from any of the connected vehicles, including information about the speed and position of the connected vehicles themselves. The traffic reconstruction module(s) 130 can also take into account the map data 122, traffic rules data 124, and/or driving behavior data 126. The traffic reconstruction module(s) 130 can solve dynamic equations/simulations to satisfy all constraints (coming from sensors and CPMs) as best as possible. The more constraints/information the traffic reconstruction module(s) 130 have, the more accurate the reconstruction becomes. By applying these models and additional data, the traffic reconstruction module(s) 130 can determine the behavior (speed, position, etc.) of the vehicles 730, 731, 732 between t₁ and t₂.

The traffic reconstruction module(s) 130 can perform other analyses and functions. Additional examples will be provided herein.

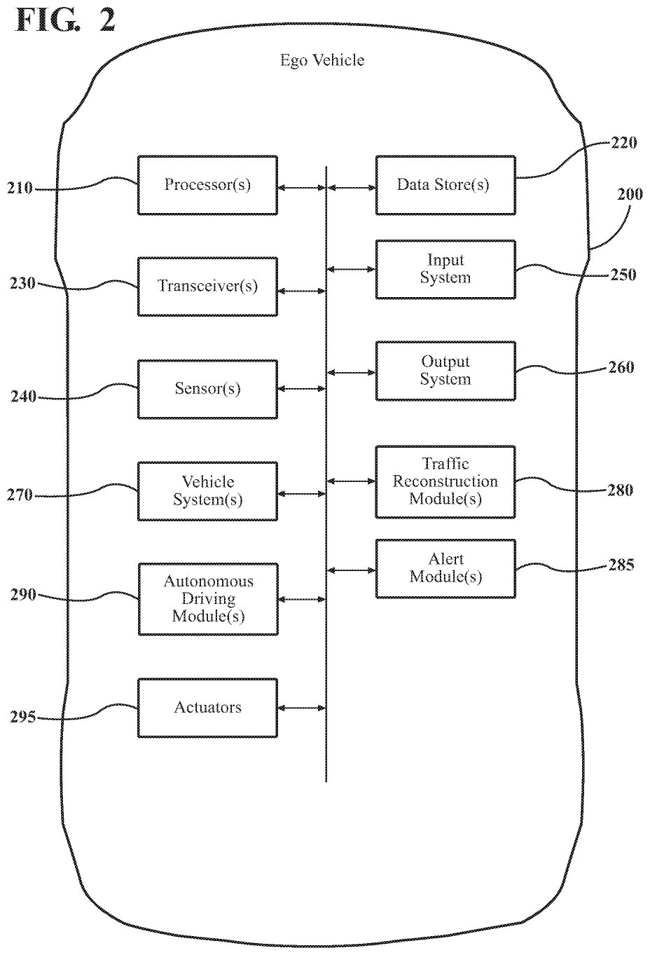

The ego vehicle 200 will now be described in greater detail. Referring to FIG. 2, an example of the ego vehicle 200 is shown. In some instances, the ego vehicle 200 can be an autonomous vehicle. As used herein, “autonomous vehicle” means a vehicle that configured to operate in an autonomous operational mode. “Autonomous operational mode” means that one or more computing systems are used to navigate and/or maneuver the vehicle along a travel route with minimal or no input from a human driver. In one or more arrangements, the ego vehicle 200 can be highly or fully automated.

The ego vehicle 200 can include one or more processors 210 and one or more data stores 220. The above-discussion of the processors 110 and data stores 120 applies equally to the processors 210 and data stores 220, respectively.

The ego vehicle 200 can include one or more transceivers 230. As used herein, “transceiver” is defined as a component or a group of components that transmit signals, receive signals or transmit and receive signals, whether wirelessly or through a hard-wired connection. The transceiver(s) 230 can enable communications between the ego vehicle 200 and other elements of the traffic reconstruction system 100. The transceiver(s) 230 can be any suitable transceivers used to access a network, access point, node or other device for the transmission and receipt of data. The transceiver(s) 230 may be wireless transceivers using any one of a number of wireless technologies, now known or in the future.

The ego vehicle 200 can include one or more sensors 240. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the ego vehicle 200 includes a plurality of sensors, the sensors can work independently from each other. Alternatively, two or more of the sensors can work in combination with each other. In such case, the two or more sensors can form a sensor network.

The sensor(s) 240 can include any suitable type of sensor. Various examples of different types of sensors will be described herein. However, it will be understood that the embodiments are not limited to the particular sensors described.

The sensor(s) 240 can include one or more vehicle sensors 241. The vehicle sensor(s) 241 can detect, determine, assess, monitor, measure, quantify and/or sense information about the ego vehicle 200 itself (e.g., position, orientation, speed, etc.). The sensor(s) 240 can include one or more environment sensors 242 configured to detect, determine, assess, monitor, measure, quantify, acquire, and/or sense driving environment data. “Driving environment data” includes and data or information about the external environment in which a vehicle is located or one or more portions thereof. For example, the environment sensor(s) 242 can detect, determine, assess, monitor, measure, quantify, acquire, and/or sense obstacles in at least a portion of the external environment of the ego vehicle 200 and/or information/data about such obstacles. Such obstacles may be stationary objects and/or dynamic objects. The environment sensors 242 can detect, determine, assess, monitor, measure, quantify, acquire, and/or sense other things in the external environment of the ego vehicle 200, such as, for example, lane markers, signs, traffic lights, traffic signs, lane lines, crosswalks, curbs proximate the ego vehicle 200, off-road objects, etc.

In one or more arrangements, the environment sensor(s) 242 can include one or more radar sensors 243, one or more lidar sensors 244, one or more sonar sensors 245, and/or one or more cameras 346. Such sensors can be used to detect, determine, assess, monitor, measure, quantify, acquire, and/or sense, directly or indirectly, something about the external environment of the ego vehicle 200. For instance, one or more of the environment sensors 242 can be used to detect, determine, assess, monitor, measure, quantify, acquire, and/or sense, directly or indirectly, the presence of one or more objects in the external environment of the ego vehicle 200, the position or location of each detected object relative to the ego vehicle 200, the distance between each detected object and the ego vehicle 200 in one or more directions (e.g. in a longitudinal direction, a lateral direction, and/or other direction(s)), the elevation of a detected object, the speed of a detected object, the acceleration of a detected object, the heading angle of a detected object, and/or the movement of each detected obstacle.

The ego vehicle 200 can include an input system 250. An “input system” includes any device, component, system, element or arrangement or groups thereof that enable information/data to be entered into a machine. The input system 250 can receive an input from a vehicle occupant (e.g. a driver or a passenger). Any suitable input system 250 can be used, including, for example, a keypad, display, touch screen, multi-touch screen, button, joystick, mouse, trackball, microphone and/or combinations thereof.

The ego vehicle 200 can include an output system 260. An “output system” includes any device, component, system, element or arrangement or groups thereof that enable information/data to be presented to a vehicle occupant (e.g. a person, a vehicle occupant, etc.). The output system 260 can present information/data to a vehicle occupant. The output system 260 can include a display. Alternatively or in addition, the output system 260 may include an earphone and/or speaker. Some components of the ego vehicle 200 may serve as both a component of the input system 250 and a component of the output system 260.

The ego vehicle 200 can include one or more vehicle systems 270. The one or more vehicle systems 270 can include a propulsion system, a braking system, a steering system, throttle system, a transmission system, a signaling system, and/or a navigation system 275. Each of these systems can include one or more mechanisms, devices, elements, components, systems, and/or combination thereof, now known or later developed. The above examples of the vehicle systems 270 are non-limiting. Indeed, it will be understood that the vehicle systems 270 can include more, fewer, or different vehicle systems. It should be appreciated that although particular vehicle systems are separately defined, each or any of the systems or portions thereof may be otherwise combined or segregated via hardware and/or software within the ego vehicle 200.

The navigation system 275 can include one or more mechanisms, devices, elements, components, systems, applications and/or combinations thereof, now known or later developed, configured to determine the geographic location of the ego vehicle 200 and/or to determine a travel route for the ego vehicle 200. The navigation system 275 can include one or more mapping applications to determine a travel route for the ego vehicle 200. The navigation system 275 can include a global positioning system, a local positioning system, or a geolocation system.

In one or more arrangements, the navigation system 275 can include a global positioning system, a local positioning system or a geolocation system. The navigation system 275 can be implemented with any one of a number of satellite positioning systems, now known or later developed, including, for example, the United States Global Positioning System (GPS). Further, the navigation system 275 can use Transmission Control Protocol (TCP) and/or a Geographic information system (GIS) and location services.

The navigation system 275 may include a transceiver configured to estimate a position of the ego vehicle 200 with respect to the Earth. For example, navigation system 275 can include a GPS transceiver to determine the vehicle's latitude, longitude and/or altitude. The navigation system 275 can use other systems (e.g. laser-based localization systems, inertial-aided GPS, and/or camera-based localization) to determine the location of the ego vehicle 200.

The ego vehicle 200 can include one or more modules, at least some of which will be described herein. The modules can be implemented as computer readable program code that, when executed by a processor, implement one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data store 220 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The ego vehicle 200 can include one or more traffic reconstruction modules 280. The above-discussion of the traffic reconstruction module(s) 130 in connection with FIG. 1 applies equally here.

The ego vehicle 200 can include one or more alert modules 285. The alert module(s) 285 can cause an alert, message, warning, and/or notification to be presented within the ego vehicle 200. The alert module(s) 285 can cause any suitable type of alert, message, warning, and/or notification to be presented, including, for example, visual, audial, and/or haptic alert, just to name a few possibilities. The alert module(s) 285 can be operatively connected to the output system(s) 260, the vehicle systems 270, and/or components thereof to cause the alert to be presented. In one or more arrangements, the alert module(s) 285 can cause a visual, audial, and/or haptic alert to be presented within the ego vehicle 200.

In some arrangements, the ego vehicle 200 can include one or more autonomous driving modules 290. The autonomous driving module(s) 290 can receive data from the sensor(s) 240 and/or any other type of system capable of capturing information relating to the ego vehicle 200 and/or the external environment of the ego vehicle 200. In one or more arrangements, the autonomous driving module(s) 290 can use such data to generate one or more driving scene models. The autonomous driving module(s) 290 can determine position and velocity of the ego vehicle 200. The autonomous driving module(s) 290 can determine the location of objects, obstacles, or other environmental features including traffic signs, trees, shrubs, neighboring vehicles, pedestrians, etc.

The autonomous driving module(s) 290 can receive, capture, and/or determine location information for obstacles within the external environment of the ego vehicle 200 for use by the processor(s) 110, and/or one or more of the modules described herein to estimate position and orientation of the ego vehicle 200, vehicle position in global coordinates based on signals from a plurality of satellites, or any other data and/or signals that could be used to determine the current state of the ego vehicle 200 or determine the position of the ego vehicle 200 in respect to its environment for use in either creating a map or determining the position of the ego vehicle 200 in respect to map data.

The autonomous driving module(s) 290 can determine travel path(s), current autonomous driving maneuvers for the ego vehicle 200, future autonomous driving maneuvers and/or modifications to current autonomous driving maneuvers based on data acquired by the sensor(s) 240, driving scene models, and/or data from any other suitable source. “Driving maneuver” means one or more actions that affect the movement of a vehicle. Examples of driving maneuvers include: accelerating, decelerating, braking, turning, moving in a lateral direction of the ego vehicle 200, changing travel lanes, merging into a travel lane, and/or reversing, just to name a few possibilities. The autonomous driving module(s) 290 can cause, directly or indirectly, such autonomous driving maneuvers to be implemented. As used herein, “cause” or “causing” means to make, force, compel, direct, command, instruct, and/or enable an event or action to occur or at least be in a state where such event or action may occur, either in a direct or indirect manner. The autonomous driving module(s) 290 can execute various vehicle functions and/or to transmit data to, receive data from, interact with, and/or control the ego vehicle 200 or one or more systems thereof (e.g. one or more of vehicle systems 170).

The ego vehicle 200 can include one or more actuators 295 to modify, adjust and/or alter one or more of the vehicle systems 270 or components thereof to responsive to receiving signals or other inputs from the processor(s) 210 and/or the autonomous driving module(s) 290. The actuators 295 can include motors, pneumatic actuators, hydraulic pistons, relays, solenoids, and/or piezoelectric actuators, just to name a few possibilities.

The processor(s) 110 and/or the autonomous driving module(s) 290 can be operatively connected to communicate with the various vehicle systems 170 and/or individual components thereof. For example, returning to FIG. 1, the processor(s) 110 and/or the autonomous driving module(s) 290 can be in communication to send and/or receive information from the various vehicle systems 170 to control the movement, speed, maneuvering, heading, direction, etc. of the ego vehicle 200. The processor(s) 110 and/or the autonomous driving module(s) 290 may control some or all of these vehicle systems 170 and, thus, may be partially or fully autonomous.

For instance, when operating in an autonomous mode, the processor(s) 110 and/or the autonomous driving module(s) 290 can control the direction and/or speed of the ego vehicle 200. The processor(s) 110 and/or the autonomous driving module(s) 290 can cause the ego vehicle 200 to accelerate (e.g., by increasing the supply of fuel provided to the engine), decelerate (e.g., by decreasing the supply of fuel to the engine and/or by applying brakes) and/or change direction (e.g., by turning the front two wheels).

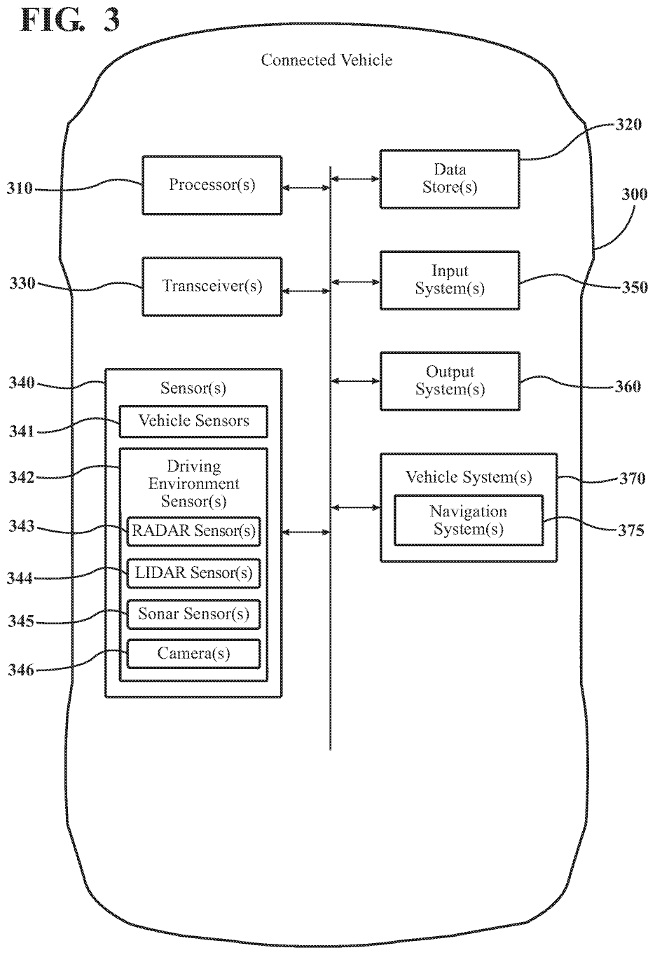

Referring to FIG. 3, an example of a connected vehicle 300 is shown. The connected vehicle 300 can include one or more processors 310, one or more data stores 320, one or more transceivers 330, one or more sensors 340, one or more input systems 350, one our more output systems 360, and one or more vehicle systems 370 including one or more navigation systems 375. The above description of the one or more processors 110 and the one or more data stores 120 in connection with the traffic reconstruction system 100 of FIG. 1 applies equally to the respective elements of the connected vehicle 300. Likewise, the above description of the processor(s) 210, the data store(s) 220, the transceiver(s) 230, the sensor(s) 240, the input system(s) 250, the output system(s) 260, and the vehicle systems(s) 270 including the navigation system(s) 275 in connection with the ego vehicle 200 applies equally to the respective elements of the connected vehicle 300.

The connected vehicle 300 can be configured to send cooperative perception messages 301, driving environment data 302, and/or other data to the ego vehicle 200 and/or the infrastructure device 400. The connected vehicle 300 can do so via the transceiver(s) 330. The connected vehicle 300 can send the cooperative perception messages 301, driving environment data 302, and/or other data at suitable time. For instance, the connected vehicle 300 can send such information continuously, periodically, irregularly, randomly, in response to a request from the ego vehicle 200 or infrastructure device 400, or upon the occurrence or detection of an event or condition.

The connected vehicle 300 may be an autonomous vehicle, a semi-autonomous vehicle, or a manual vehicle. In some arrangements, the connected vehicle 300 can be configured to switch between any combination of operation modes (e.g., autonomous, semi-autonomous, or manual). The connected vehicle 300 may include any of the other elements shown in FIG. 2 in connection with the ego vehicle 200.

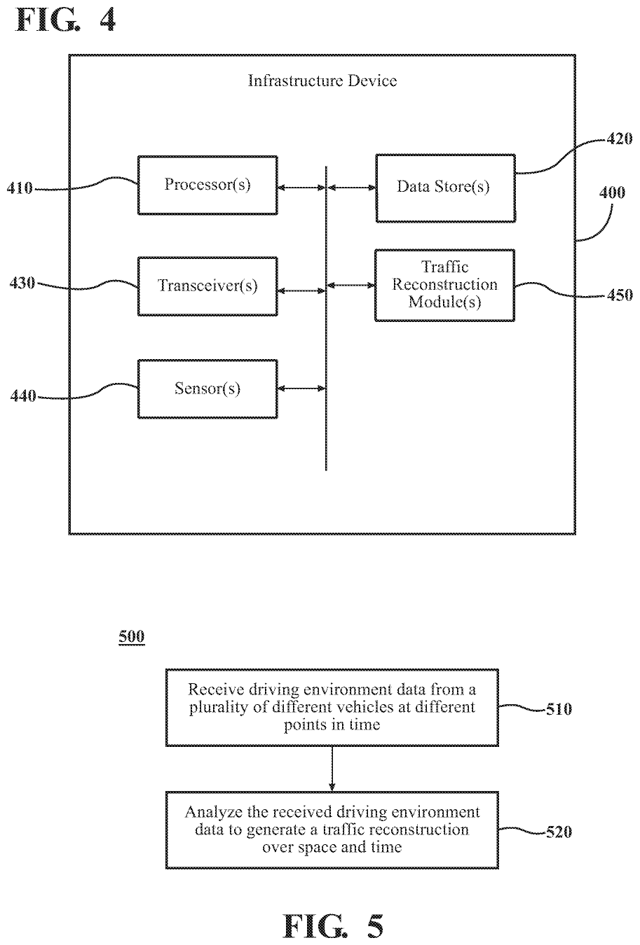

Referring to FIG. 4, an example of an infrastructure device 400 is shown. The infrastructure device 400 can include one or more processors 410, one or more data stores 420, one or more transceivers 430, one or more sensors 440, and one or more traffic reconstruction modules 450. The above description of the one or more processors 110, the one or more data stores 120, and the one or more traffic reconstruction modules 130 in connection with the traffic reconstruction system 100 of FIG. 1 applies equally to the respective elements of the connected vehicle 300. Likewise, the above description of the processor(s) 210, the data store(s) 220, the transceiver(s) 230, and the sensor(s) 240 in connection with the ego vehicle 200 applies equally to the respective elements of the infrastructure device 400.

Now that the various potential systems, devices, elements and/or components of the traffic reconstruction system 100 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

Turning to FIG. 5, an example of a method 500 of reconstructing traffic is shown. At block 510, environment data (e.g., cooperative perception messages 301, driving environment data 302, and/or other data) can be received from a plurality of connected vehicles. The environment data can be from different moments in time. The environment data can be received by the ego vehicle 200 or the infrastructure device 400. The method 500 can continue to block 520.

At block 520, the received environment data can be analyzed to generate a traffic reconstruction. The traffic reconstruction can span over space as well as time. The traffic reconstruction can be generated by the traffic reconstruction module(s) 130, 280, or 450 and/or the processor(s) 110, 210, or 410. The map data 122, the traffic rules data 124, and/or the driving behavior data 126 can also be used in generating the traffic reconstruction.

The method 500 can end. Alternatively, the method 500 can return to block 510 or to some other block. The method 500 can be repeated at any suitable point, such as at a suitable time or upon the occurrence of any suitable event or condition.

The traffic reconstruction generated according to arrangements herein can be used for various purposes. For instance, the traffic reconstruction can be sent to other vehicles. The other vehicles can use the traffic reconstruction to make driving decisions (e.g., change lanes, slow down speed up, change routing, etc.). In some arrangements, the vehicle can provide recommendations or warnings to a vehicle occupant based on the traffic reconstruction. For example, the alert module(s) 285 can cause a message, alert, or warning to be presented in the ego vehicle 200, such as via the output system 260. In some arrangements, such as when the vehicle is an autonomous vehicle, the vehicle can use the traffic reconstruction to make a driving decision, such as by using the autonomous driving module(s) 290. In some arrangements, the autonomous vehicle can be configured to implement driving decision, such as by the autonomous driving module(s) 290 and/or the actuator(s) 295.

The traffic reconstruction can be sent to one or more repositories. This data can be used for subsequent review and/or analysis by any suitable person or entity. The traffic reconstruction can be sent to an infrastructure device. The infrastructure device may aggregate traffic reconstructions generated by a plurality of vehicles to obtain a big picture view of what is happening on the road. In some arrangements, the infrastructure device may broadcast messages (e.g., warnings) to vehicles on the road.

The traffic reconstruction can be used as part of a crowdsourcing effort. For instance, a first ego vehicle may have collected a detailed picture of what is happening on the road with respect to a certain kinds of car (e.g., make, model, type, color, etc.). Another ego vehicle elsewhere can collect a detailed picture of what is happening with certain kinds of cars. The data from these and other vehicles can collectively result in a larger traffic reconstruction being generated.

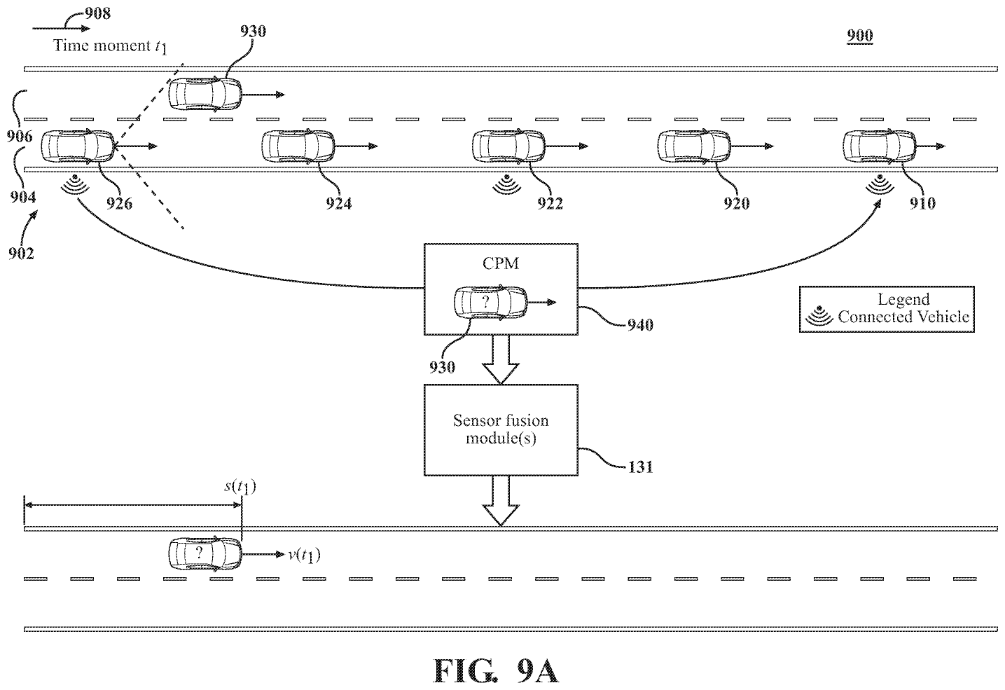

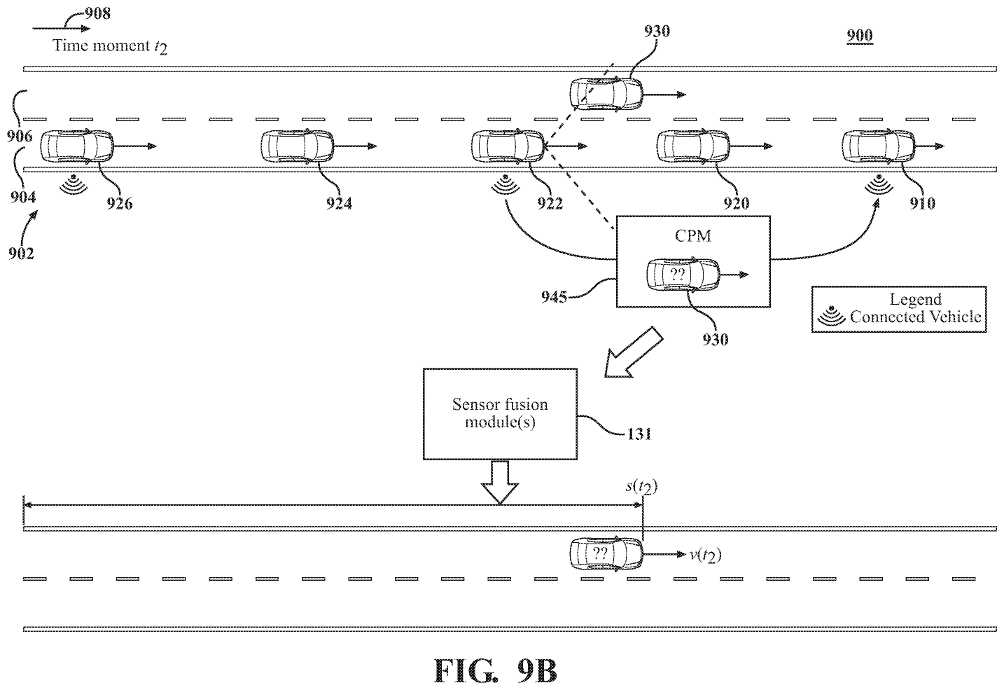

Non-limiting examples of the operation of the arrangements described herein will now be presented in connection to FIGS. 9-16.

A first example of the use of arrangements described herein will now be described in connection with FIGS. 9-13. Referring to FIG. 9A, a driving environment 900 at a first moment in time is shown. The driving environment 900 can include a road 902 with a first travel lane 904 and a second travel lane 906. A travel direction 908 of the first travel lane 904 and the second travel lane 906 can be the same. The driving environment 900 can include an ego vehicle 910 and a plurality of vehicles. In this example, vehicles 922, 926 can be connected vehicles. Vehicles 920, 924, 930 can be connected vehicles, non-connected vehicles, or any combination thereof. A non-connected vehicle is a vehicle that is not communicatively coupled to the ego vehicle 910. The ego vehicle 910, the connected vehicles 922, 926, and the vehicles 920, 924 can be located in the first travel lane 904. The vehicle 930 can be located in the second travel lane 906.

FIG. 9A shows the driving environment 900 at a first moment in time t₁. At the first moment in time t₁, the connected vehicle 926 can sense the driving environment 900. The connected vehicle 926 can detect the vehicle 930. More particularly, the connected vehicle 926 can detect the position and speed information about the vehicle 930 at the first moment in time t₁. The connected vehicle 926 can send a cooperative perception message 940 to the ego vehicle 910. The cooperative perception message 940 can include position and speed information about the vehicle 930 at the first moment in time t₁. While, in this example, the connected vehicle 926 sends the position and speed information to the ego vehicle 910 by the cooperative perception message 940, it will be appreciated that the connected vehicle 926 can send the position and speed information in any suitable manner, including in other manners that are not cooperative perception messages. It should be noted that the connected vehicle 922 and/or other connected vehicles can also be sensing the driving environment 900 at the first moment in time t₁.

It should be noted that the traffic reconstruction module(s) 130 and/or the sensor fusion module(s) 131 may know that this object is a vehicle, or the module(s) may assume that the object is a vehicle. However, these module(s) do not necessarily know the identity of the detected vehicle, as the CPM may not include global identification. Thus, the module(s) may not know that the detected vehicle is the vehicle 930. Accordingly, in the lower part of FIG. 9A, the detected vehicle is shown with the label “?” The module(s) can recognize that vehicle “?” is located at s(t₁) and has speed v(t₁).

Referring to FIG. 9B, the driving environment 900 at a second moment in time t₂ is shown. The vehicle 930 has traveled forward in the second travel lane 906 such that it has passed the connected vehicle 922 and the vehicle 924 in the travel direction 908. The connected vehicle 922 can sense the driving environment. The connected vehicle 922 can detect the vehicle 930. The connected vehicle 922 can send a cooperative perception message 945 to the ego vehicle 910. The cooperative perception message 945 can include position and speed information about the vehicle 930 at the second moment in time t₂. While, in this example, the connected vehicle 922 sends the position and speed information to the ego vehicle 910 by the cooperative perception message 945, it will be appreciated that the connected vehicle 922 can send the position and speed information in any suitable manner, including in other manners that are not cooperative perception messages.

The traffic reconstruction module(s) 130 and/or the sensor fusion module(s) 131 may know that this object is a vehicle, or the module(s) may assume that the object is a vehicle. However, these module(s) do not necessarily know the identity of the detected vehicle, as the CPM may not include global identification. Thus, the module(s) may not know that the detected vehicle is the vehicle 930. Accordingly, in the lower part of FIG. 9B, the detected vehicle is shown with the label “??”. The module(s) can recognize that vehicle “??” is located at s(t₂) and has speed v(t₂). From the CPMs, 940, 945, the traffic reconstruction module(s) 130 and/or the sensor fusion module(s) 131 may not understand at this point that vehicle “?” and vehicle “??” are the same vehicle (vehicle 930).

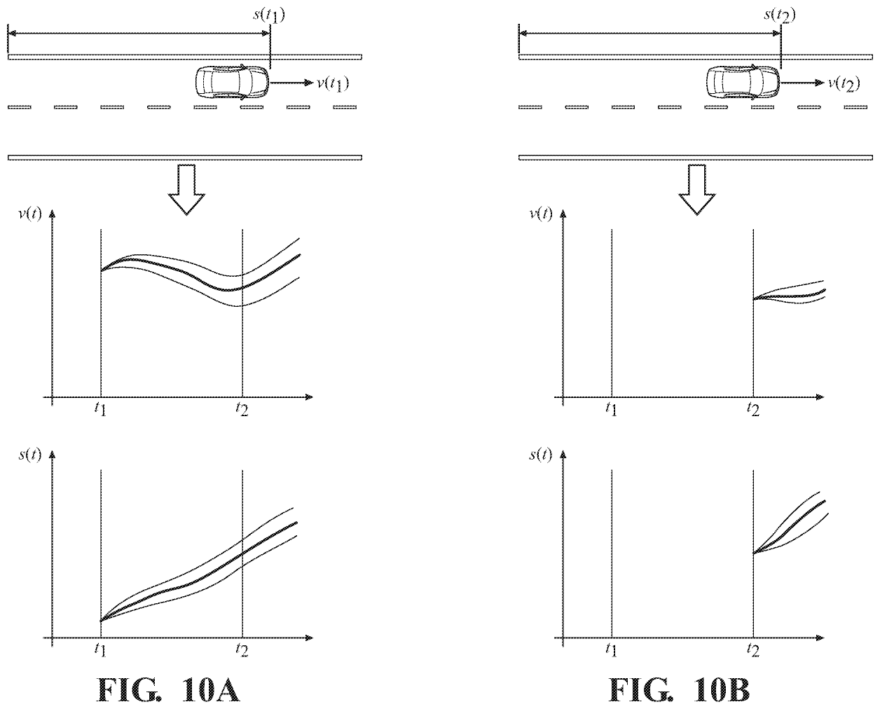

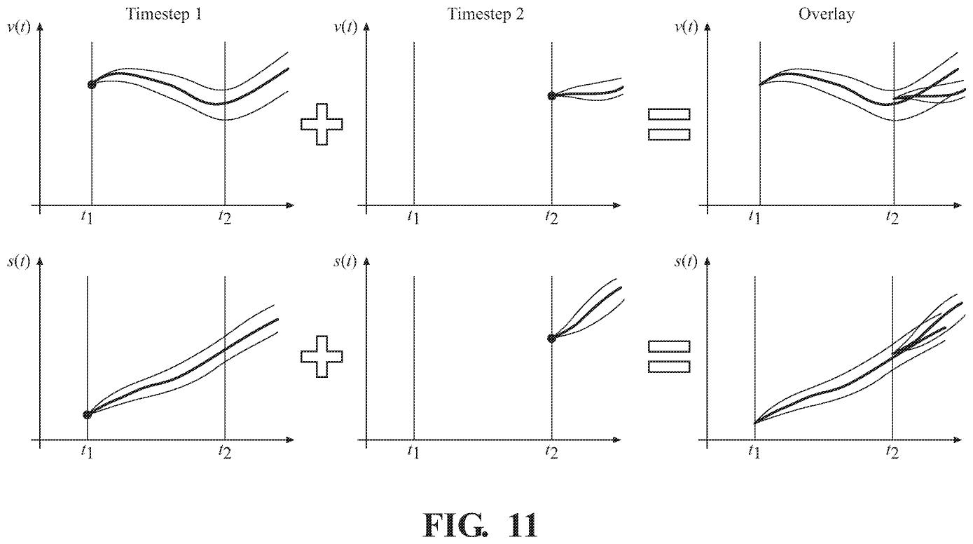

The cooperative perception messages 940, 945 can be sent to the traffic reconstruction module(s) 130. FIGS. 10A and 11A show the information available to the traffic reconstruction module(s) 130. In FIGS. 10B-10C, the traffic reconstruction module(s) 130 and/or the reconstruction module(s) 132 can take the information from the cooperative perception message 940 at the first moment in time t₁. Using traffic rules, dynamic models, and/or other information, the traffic reconstruction module(s) 130 and/or the reconstruction module(s) 132 can extrapolate the position and speed of the object within probabilistic bounds, including at time t₂ and possibly beyond. The traffic reconstruction module(s) 130 and/or the reconstruction module(s) 132 can predict the future speed(s) and positions(s) of the vehicle “?” along with upper and lower probabilistic limits.

Likewise, in FIGS. 11B-11C, the traffic reconstruction module(s) 130 and/or the reconstruction module(s) 132 can use the information from the cooperative perception message 945 at the second moment in time t₂. Using traffic rules, dynamic models, and/or other information, the traffic reconstruction module(s) 130 can extrapolate the position and speed of the object into the future. The traffic reconstruction module(s) 130 and/or the reconstruction module(s) 132 can predict the future speed(s) and positions(s) of the vehicle “??” along with upper and lower probabilistic limits.

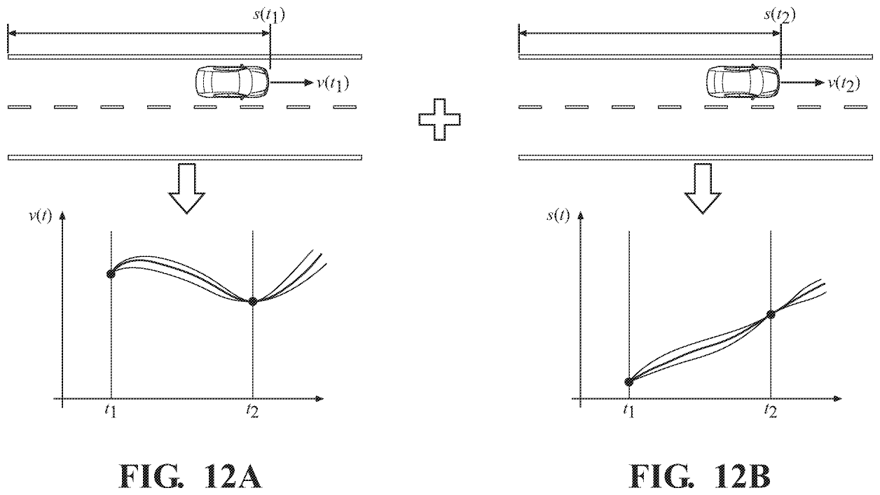

Next, as is shown in FIGS. 12A-12B, the traffic reconstruction module(s) 130 can overlay the speed data and the position data associated with the first and second moments in time t₁, t₂. As can be seen, there is a significant overlap between the two solutions in this instance (e.g., an amount of overlap above a predetermined threshold). The speed data at time stamp t₂ falls within the upper limit and the lower limit of the speed data extrapolated from the first moment in time t₁. Further, the position data at the second moment in time t₂ falls within the upper limit and the lower limit of the position data at and extrapolated from t₂. As a result, the traffic reconstruction module(s) and/or the reconstruction module(s) 132 can determine that vehicle “?” and vehicle “??” are the same vehicle/object.

Alternatively or additionally to the above, the determination that vehicle “?” and vehicle “??” are the same vehicle can be performed in other ways. For instance, based on camera data, vehicle “?” and vehicle “??” can be determined to be vehicles of the same make, model, and/or color. This information can be used to further improve the accuracy of the conclusion whether “?” and “??” are the same vehicle. For instance if we detect that the vehicles “?” and “??” have the same make, model and color, then the reconstruction module will have a higher confidence to conclude the vehicles are the same. If on the other hand these vehicles are classified to be not the same color, make and model, this will reduce the reconstruction module's confidence in classifying car “?” and “??” as being the same vehicle.

If the traffic reconstruction module(s) 130 and/or reconstruction module(s) 132 also detects these vehicles being in the same lane and going the same speed, then the module(s) can determine that vehicle “?” and vehicle “??” are the same object.

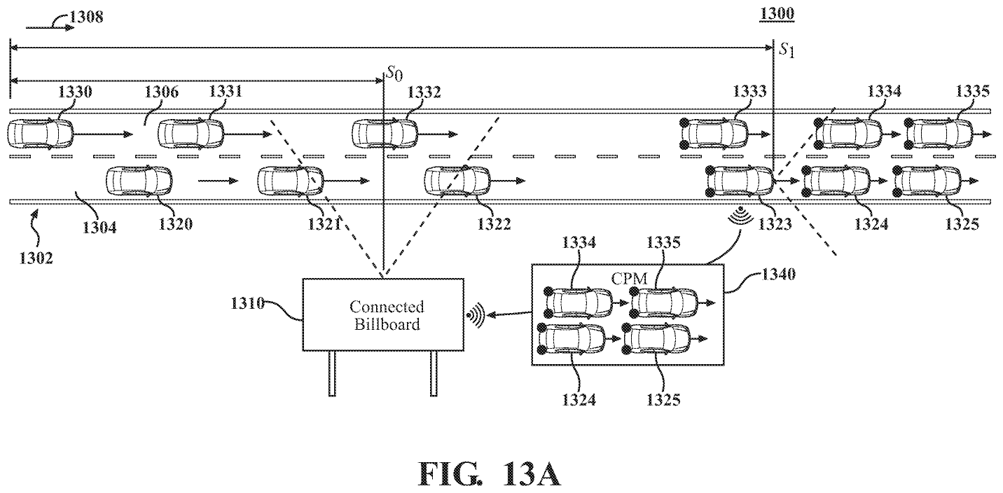

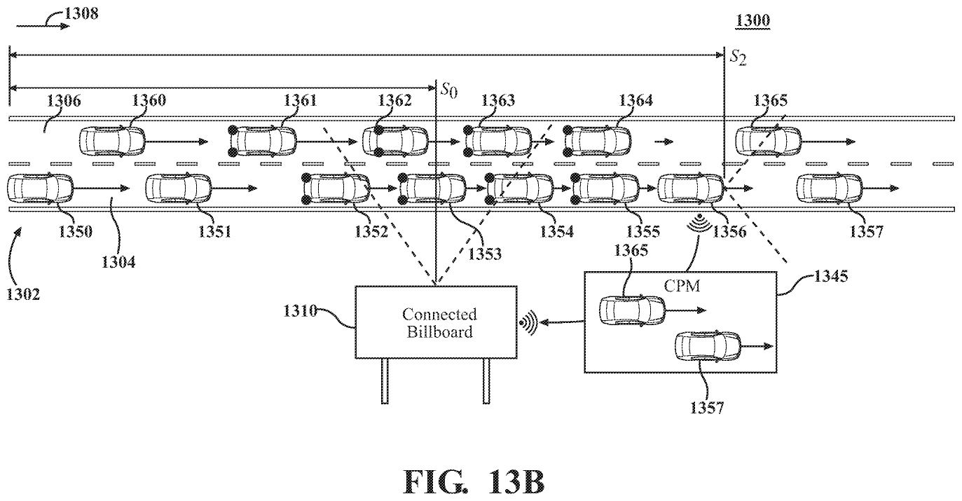

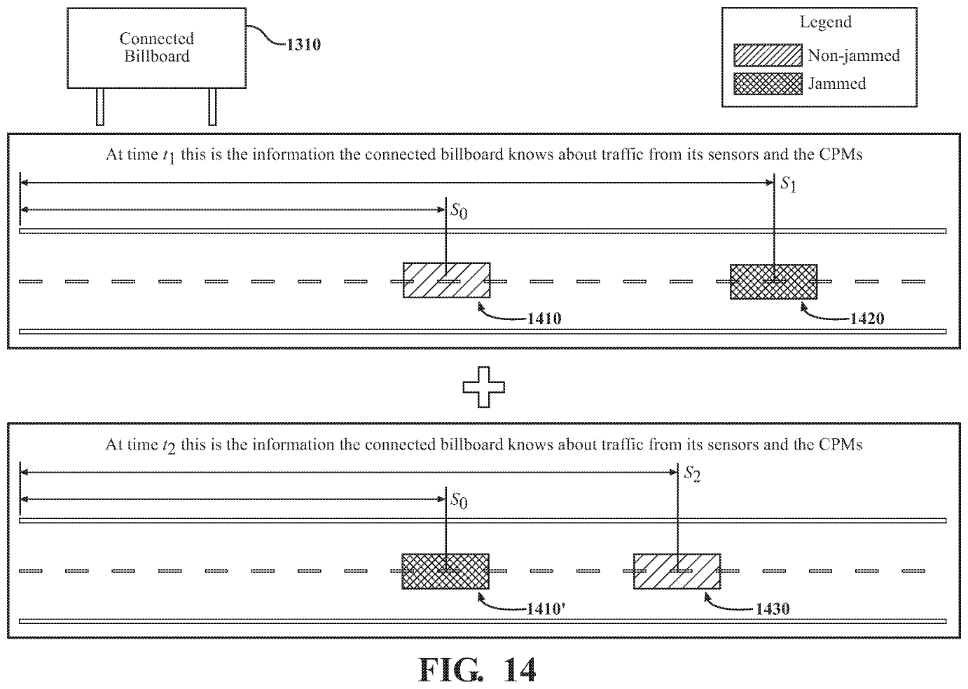

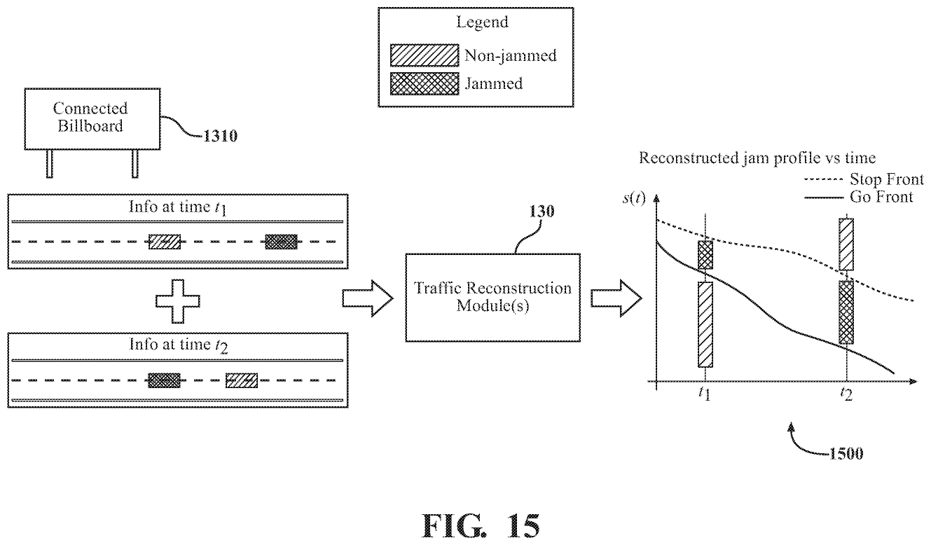

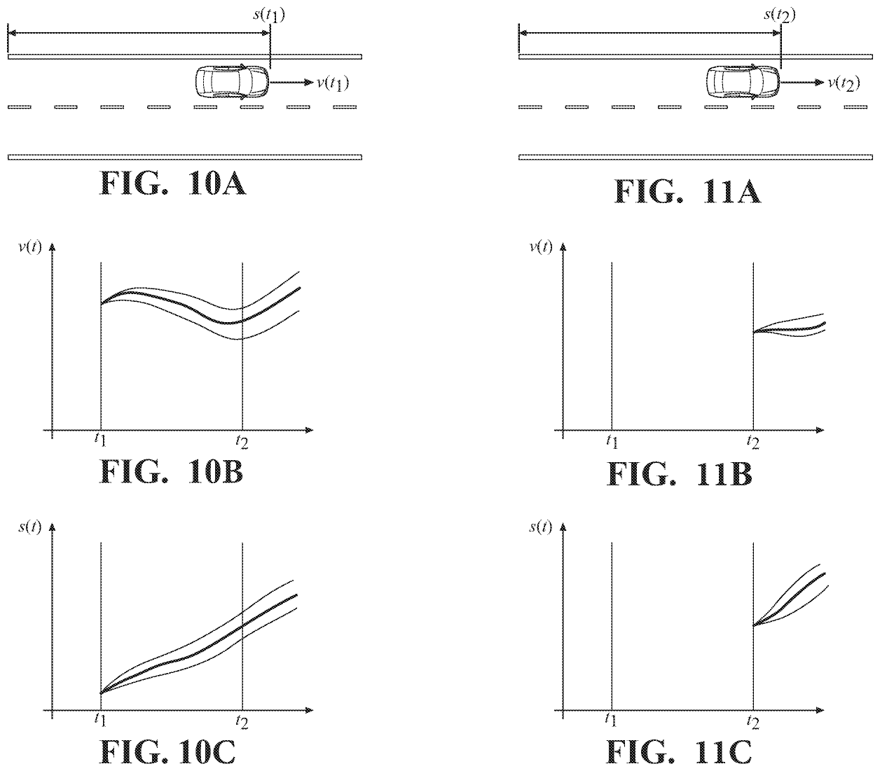

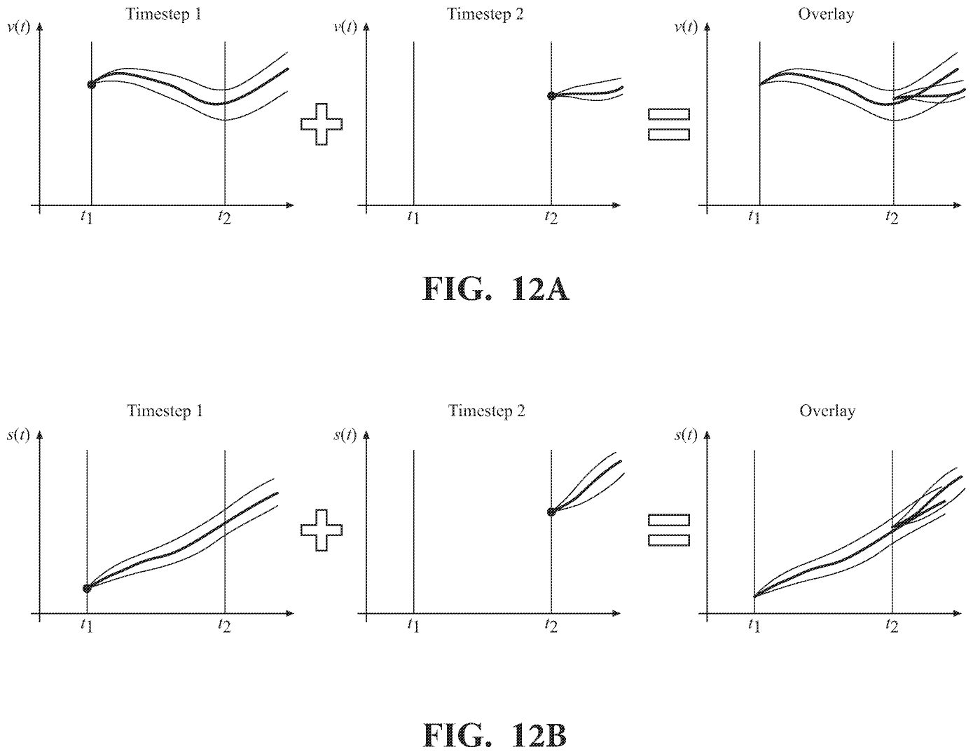

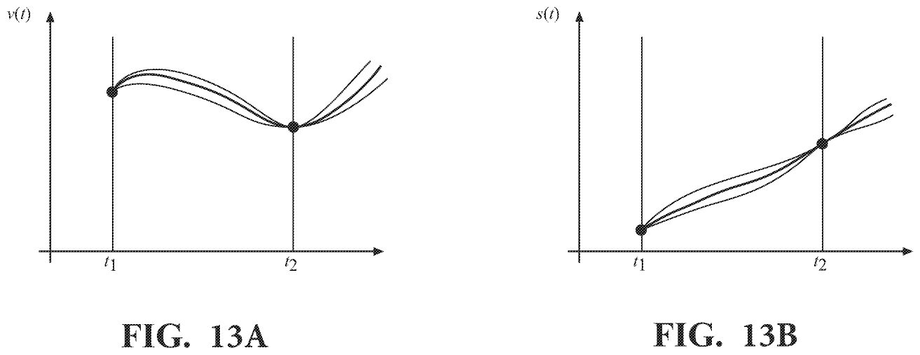

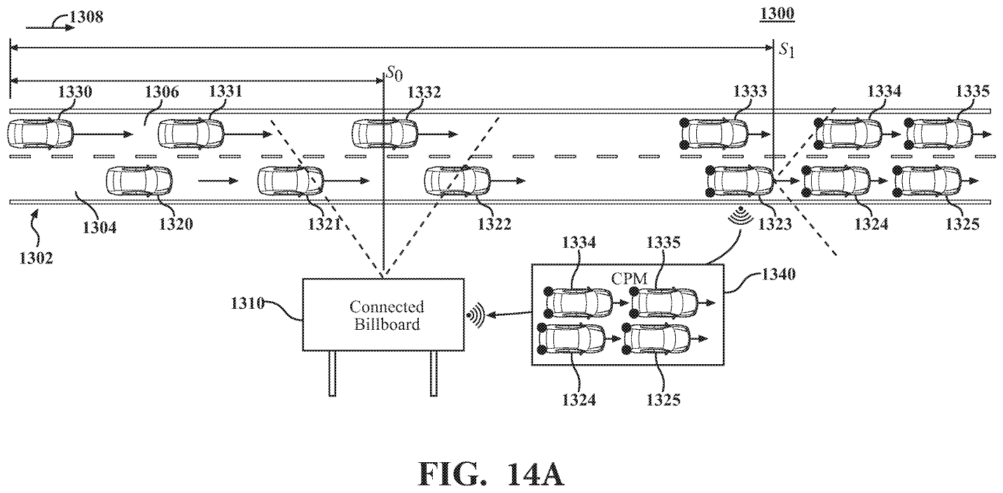

Once it is know that the information in the cooperative perception messages 940, 195 pertain to the same object, the traffic reconstruction module(s) 130 and/or the reconstruction module(s) 132 can generate a posterior reconstruction and can refine the reconstructed trajectory of the vehicle. The traffic reconstruction module(s) 130 and/or the reconstruction module(s) 132 can determine what occurred between t₁ and t₂ with respect to speed and position of the object. The traffic reconstruction module(s) can do so in any suitable manner, such as by applying the map data 122, the traffic rules data 124, the driving behavior data 126, and/or other information noted above. FIG. 13A shows an example of a traffic reconstruction of the speed profile for the object, and FIG. 13B shows an example of the traffic reconstruction of the position profile for the object. At this point, the traffic reconstruction module(s) 130 will understand that the object is a single vehicle, how the vehicle looks like from different angles and at different times, and the position and speed of the vehicle to a high accuracy over the time interval between the first and second moments in time t₁ and t₂. The visualization module(s) 133 can be used to project this vehicle into different coordinate frames/viewpoints.

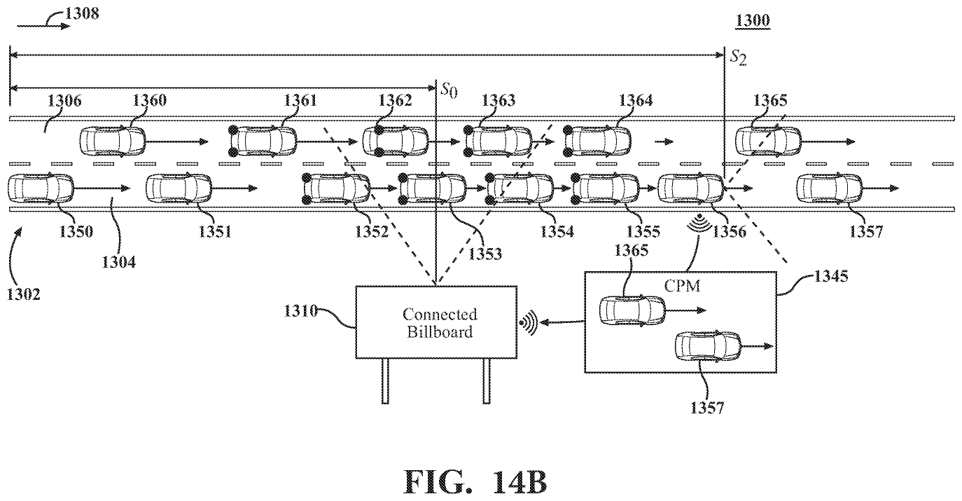

A second example of the use of arrangements described herein will now be described in connection with FIGS. 14A-14B. Referring to FIG. 14A, a driving environment 1300 at a first moment in time t₁ is shown. The driving environment 1300 can include a road 1302 with a first travel lane 1304 and a second travel lane 1306. The travel direction 1308 of the first travel lane 1304 and the second travel lane 1306 can be the same.

The driving environment 1300 can include a connected billboard 1310 located along the road 1302. The connected billboard 1310 can include one or more sensors for sensing the driving environment 1300. The driving environment 1300 can include a plurality of vehicles 1320, 1321, 1322, 1323, 1324, 1325, which can be located in the first travel lane 1304. In this example, the vehicle 1323 can be a connected vehicle and can be communicatively coupled to the connected billboard 1310. The vehicles 1320, 1321, 1322, 1324, 1325 can be connected vehicles, non-connected vehicles, or any combination thereof. In this example, a non-connected vehicle is a vehicle that is not communicatively coupled to the connected billboard 1310. The plurality of vehicles 1320, 1321, 1322, 1323, 1324, 1325 can be observed by the sensors on the connected billboard 1310. In some embodiments a subset of these vehicles or all these vehicles can be connected. The driving environment 1300 can include second travel lane 1306 with vehicles 1330, 1331, 1332, 1333, 1334, 1335, which can be connected vehicles, non-connected vehicles, or any combination thereof.

FIG. 14A shows the driving environment 1300 at a first moment in time t₁. There can be a traffic jam forming toward the right side of FIG. 14A. The vehicles 1323, 1324, 1325, 1333, 1334, 1335 may be applying their brakes, causing their brake lights to be illuminated.

At the first moment in time t₁, the connected billboard 1310 can sense the driving environment 1300, such as via a camera. The connected billboard can detect vehicles 1321, 1322, and 1332. These vehicles may or may not be connected. In the case that none of these vehicles are connected, they are simply detected by the sensors on the connected billboard 1310. In the case that one or more of these vehicles are connected, they can provide additional information to the connected billboard 1310. This information can include the positions, speeds, and/or headings of these vehicles. The vehicles 1321, 1322, and 1332 are sparsely distributed and do not have their brake lights illuminated. Based on the information detected, the connected billboard 1310 may observe that traffic is a sparse state (non-jammed) around location so.

Also, at the first moment in time, the connected vehicle 1323 at position s₁ can sense the driving environment. The connected vehicle 1323 can detect vehicles 1324, 1325, 1334, 1335, including the position and/or speed data of these vehicles. The connected vehicle 1323 can send the detected information to the connected billboard via, for example, a cooperative perception message 1340. The CPM 1340 can show traffic in a jammed state around position s₁.

Referring to FIG. 14B, the driving environment 1300 at a second moment in time t₂ is shown. The driving environment 1300 can include a plurality of vehicles 1350, 1351, 1352, 1353, 1354, 1355, 1356, 1357, which can be located in the first travel lane 1304. In this example, the vehicle 1356 can be a connected vehicle and can be communicatively coupled to the connected billboard 1310. The vehicles 1350, 1351, 1352, 1353, 1354, 1355, 1356, 1357 can be connected vehicles, non-connected vehicles, or any combination thereof. The driving environment 1300 can also include a plurality of vehicles 1360, 1361, 1362, 1363, 1364, 1365 located in the second travel lane 1306. The vehicles 1360, 1361, 1362, 1363, 1364, 1365 can be connected vehicles, non-connected vehicles, or any combination thereof. It should be noted that one or more of the vehicles in FIG. 14A can be one of the vehicles in FIG. 14B.

At the second moment in time t₂, the traffic jam downstream of the connected billboard 1310 has cleared up and the vehicles are now moving. However, a traffic jam has formed in the vicinity of the connected billboard 1310. Vehicles 1352, 1353, 1354, and 1355 in the first travel lane 1304 may be applying their brakes, causing their brake light to be illuminated. Likewise, vehicles 1361, 1362, 1363, and 1364 in the second travel lane may also be braking, and the brake lights of these vehicles can be illuminated.

At the second moment in time t₂, the connected billboard 1310 can sense the driving environment 1300. The connected billboard 1310 can detect the vehicles 1353, 1354, 1362, 1363, including the position and/or speed data of these vehicles. Based on the information detected, the connected billboard 1310 may observe that traffic is in a jammed state around location so.

Also, at the second moment in time t₂, the connected vehicle 1356 can sense the driving environment. The connected vehicle 1356 can detect the vehicles 1357, 1365, including the position and/or speed data of these vehicles. The connected vehicle 1356 can send the detected information to the connected billboard 1310 via, for example, a cooperative perception message 1345. The CPM 1345 can show traffic as being in a sparse state (non-jammed) around position 52.

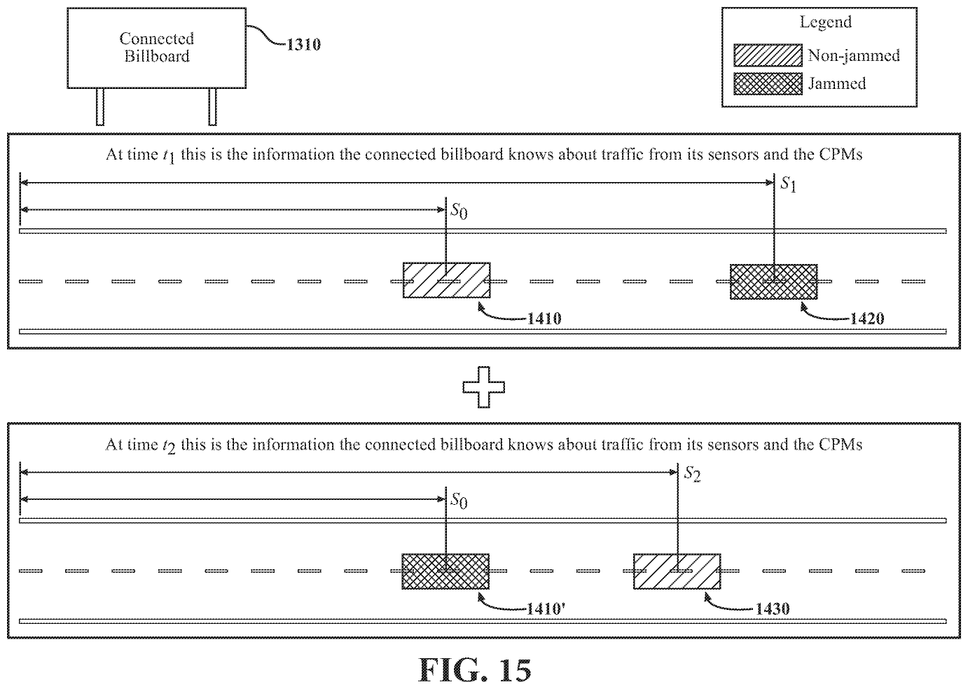

FIG. 15 shows the information that the connected billboard 1310 has acquired about traffic on the road 1302 from its own sensors as well as from the cooperative perception messages 1340, 1345. Based on the acquired information, the connected billboard 1310 can determine that, at the first moment in time t₁, traffic in region 1410 around position so is in a sparse state (e.g., vehicles are traveling at or near the speed limit on the road 1302). Further, the connected billboard 1310 can determine that traffic in region 1420 around position Si is jammed (e.g., vehicles are at a standstill, traveling at a substantially lower speed that the vehicles in region 1420, etc.). Based on the acquired information, the connected billboard 1310 can determine that, at the second moment in time t₂, traffic in region 1410′ around position so is jammed. Region 1410′ can be substantially the same as region 1410. Further, the connected billboard 1310 can determine that traffic in region 1430 at position 52 is not jammed.

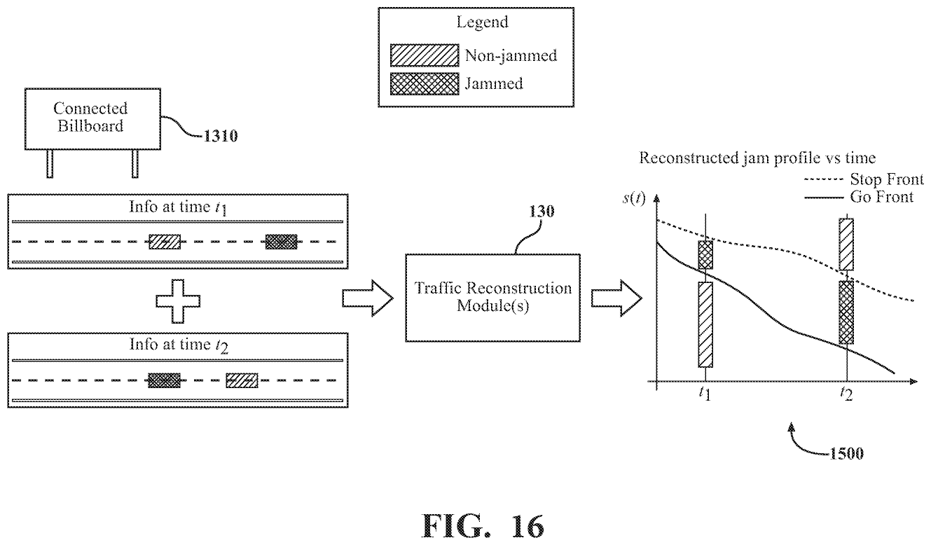

Referring to FIG. 16, the acquired information can be input into the traffic reconstruction module(s) 130. The traffic reconstruction module(s) 130 can generate a traffic reconstruction 1500 of a reconstructed traffic jam profile versus time. The traffic reconstruction 1500 can include a stop front and a go front of the traffic jam over time. The traffic reconstruction module(s) 130 can use microscopic and/or macroscopic traffic models to reconstruct how the traffic jam moves or will move. Further, the traffic reconstruction module(s) 130 can use microscopic and/or macroscopic traffic models to reconstruct how severe the traffic jam will get.

From the traffic reconstruction 1500, predictions can be made about how the traffic jam will evolve. Further, the traffic reconstruction 1500 can be used for route-planning in real-time. The traffic reconstruction 1500 can also be used to store macroscopic traffic data. In some arrangements, the traffic reconstruction 1500 can be used to control the motion of one or more automate vehicles, which can relieve traffic jams. The example described in connection with FIGS. 14-16 can alternatively be carried out on a vehicle to mitigate traffic and/or to help other surrounding vehicles to mitigate traffic.

It will be appreciated that arrangements described herein can provide numerous benefits, including one or more of the benefits mentioned herein. For example, arrangements described herein can generate a dynamic traffic reconstruction of the surrounding environment. Arrangements described herein can use dynamical models to effectively fill in the gaps between the information received via sensors to create a complete/panoramic model/view of a driving environment or traffic scenario. A traffic reconstruction generated according to arrangements described herein can be used in vehicle decision making or used in later analysis. Arrangements described herein can create a high fidelity data set.

The traffic reconstructions described herein can be performed by individual vehicles or infrastructure devices. Traffic reconstruction can be performed at any time desired when there is the minimal data to do so. Our invention also does not use requests to upload sensor data to a server by means of an alert flag. In some examples, arrangements described herein can use ad hoc communication rather than triggered by a specific request or the occurrence of a specific event. Further, in some instances, arrangements described herein can generate traffic reconstructions locally on a vehicle or infrastructure device, thereby avoiding the use of remote servers (e.g., a crowdsourcing server) to generate the traffic reconstruction. As such, the overall process can be streamlined.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope of the invention.

What is claimed is:

1. A traffic reconstruction system comprising:
one or more processors, the one or more processors being programmed to initiate executable operations comprising:
receiving driving environment data from at least one of a plurality of connected vehicles and one or more infrastructure devices at different moments in time, the driving environment data including at least position data of one or more objects in a driving environment; and
analyzing the received driving environment data to generate a traffic reconstruction, the traffic reconstruction spanning over space and time.

2. The traffic reconstruction system of claim 1, wherein the one or more processors are located onboard an ego vehicle.

3. The traffic reconstruction system of claim 2, wherein the executable operations further include:
determining a driving maneuver for the ego vehicle based on the traffic reconstruction; and
causing the ego vehicle to implement the determined driving maneuver.

4. The traffic reconstruction system of claim 1, wherein the executable operations further include:
causing a warning or message to be presented to an occupant of a vehicle based on the traffic reconstruction, or
causing a waning or message to be displayed or generated on a connected infrastructure device.

5. The traffic reconstruction system of claim 1, wherein the one or more processors are a part of an infrastructure device.

6. The traffic reconstruction system of claim 5, wherein the executable operations further include:
transmitting the traffic reconstruction to one or more connected vehicles.

7. The traffic reconstruction system of claim 5, wherein the infrastructure device is one of a sign, a traffic light, or a billboard.

8. The traffic reconstruction system of claim 1, wherein the received driving environment data includes cooperative perception messages.

9. The traffic reconstruction system of claim 1, wherein the executable operations further include:
transmitting the traffic reconstruction to a data store, an infrastructure device, or a connected vehicle.

10. The traffic reconstruction system of claim 1, wherein the traffic reconstruction includes a traffic jam profile.

11. The traffic reconstruction system of claim 1, wherein the executable operations further include:
causing a request for driving environment data to be sent to a plurality of connected vehicles, and wherein the driving environment data is received from the plurality of connected vehicles in response to the request.

12. The traffic reconstruction system of claim 1, wherein analyzing the received driving environment data to generate a traffic reconstruction includes:
using traffic rules or car following rules to predict movement of vehicles between two moments in time.

13. The traffic reconstruction system of claim 1, wherein analyzing the received driving environment data to generate a traffic reconstruction includes:
dynamic modeling of the vehicles included in the driving environment data.

14. A traffic reconstruction method comprising:
receiving driving environment data from at least one of a plurality of connected vehicles and one or more infrastructure devices at different moments in time, the driving environment data including at least position data of one or more objects in a driving environment; and
analyzing the received driving environment data to generate a traffic reconstruction, the traffic reconstruction spanning over space and time.

15. The traffic reconstruction method of claim 14, further including:
determining a driving maneuver for an ego vehicle based on the traffic reconstruction; and
causing the ego vehicle to implement the determined driving maneuver.

16. The traffic reconstruction method of claim 14, further including:
causing a warning or message to be presented to an occupant of a vehicle based on the traffic reconstruction, or
causing a waning or message to be displayed or generated on a connected infrastructure device.

17. The traffic reconstruction method of claim 14, further including:
transmitting the traffic reconstruction to a data store, an infrastructure device, or a connected vehicle.

18. The traffic reconstruction method of claim 14, further including:
causing a request for driving environment data to be sent to a plurality of connected vehicles, and wherein the driving environment data is received from the plurality of connected vehicles in response to the request.

19. The traffic reconstruction method of claim 14, wherein analyze the received driving environment data to generate a traffic reconstruction includes at least one of:
using traffic rules or car following rules to predict movement of vehicles between two moments in time; and
dynamic modeling of the vehicles included in the driving environment data.

20. A computer program product for traffic reconstruction, the computer program product comprising a computer readable storage medium having program code embodied therewith, the program code executable by a processor to perform a method comprising:
receiving driving environment data from at least one of a plurality of connected vehicles and one or more infrastructure devices at different moments in time, the driving environment data including at least position data of one or more objects in a driving environment; and
analyzing the received driving environment data to generate a traffic reconstruction, the traffic reconstruction spanning over space and time.
